(19) United States
(12) Patent Application Publication
(10) Pub. No.: US 2019/0002743 A1
(43) Pub. Date: Jan. 3, 2019

(54) LOW-EMULSIFIER AQUEOUS POLYMER DISPERSIONS FOR PRODUCTION OF COMPOSITE FILMS

(71) Applicant: BASF SE, Ludwigshafen am Rhein (DE)

(72) Inventors: Christine TONHAUSER, Ludwigshafen (DE); Karl-Heinz SCHUMACHER, Ludwigshafen (DE); Georg LANGHAUSER, Ludwigshafen (DE); Sindy SCHUSTER, Ludwigshafen (DE); Christoph KIENER, Ludwigshafen (DE); Matthias ZORN, Ludwigshafen (DE)

(73) Assignee: BASF SE, Ludwigshafen am Rhein (DE)

(21) Appl. No.: 16/063,008

(22) PCT Filed: Dec. 7, 2016
(86) PCT No.: PCT/EP2016/080061

§ 371 Date: Jun. 15, 2018

(30) Foreign Application Priority Data
Dec. 17, 2015 (EP) 15200689.6

(51) Int. Cl. C09J 133/08; C08F 220/18; B32B 7/12

(52) U.S. Cl. CPC C09J 133/08; C08F 220/18; B32B 27/08; C08F 2220/1825; B32B 2264/025; B32B 7/12

(57) ABSTRACT

Described are aqueous polymer dispersions and a method for producing them. The polymer dispersions comprise polymer particles having an average particle diameter of greater than 200 nm, monomodal particle size distribution, and uniform glass transition temperature, and are prepared by radical emulsion polymerization of a monomer mixture comprising ethylenically unsaturated, radically polymerizable monomers, using a polymer seed, less than 0.8 part by weight of emulsifier, and without protective colloids. The monomer mixture consists of a) at least 60 wt % of at least one monomer selected from the group consisting of C1 to C20 alkyl acrylates, C1 to C20 alkyl methacrylates, vinyl esters of carboxylic acids containing up to 20 carbons, vinylaromatics having up to 20 carbons, ethylenically ensaturated nitriles, vinyl halides, vinyl ethers of alcohols containing 1 to 10 carbons, aliphatic hydrocarbons having 2 to 8 carbons and one or two double bonds, and mixtures of these monomers, b) at least 0.1 wt % of at least one monomer having at least one acid group; c) optionally further monomers, the acid groups of the monomers b) being wholly or partly neutralized during the emulsion polymerization. The aqueous polymer dispersions can be used as adhesives, more particularly for the production of composite films.

The invention relates to certain low-emulsifier, aqueous polymer dispersions, to a method for producing them, and to their use as adhesives, more particularly for producing composite films.

There is a great demand for inexpensive adhesives for composite film lamination with good performance properties, for flexible food packaging, for example. Widespread in that utility are adhesive systems based on organic solvents. For the reduction of organic solvent emissions, water-based adhesive systems represent one alternative. Particular importance is possessed by acrylate ester polymer dispersions, also known as acrylate latex. Adhesives based on acrylate esters are described in WO 98/23656 and in WO 00/50480, for example. During the use of polymer dispersions prepared by emulsion polymerization using emulsifiers, there may be unwanted formation of foam during film coating by machine. It is known practice in principle to carry out emulsion polymerization substantially without emulsifiers as well, if protective colloids are used in place of the emulsifiers. Typical protective colloids are polymers containing acid groups that are water-soluble on neutralization of the acid groups at elevated pH levels. However, the protective colloids may act as foam stabilizers, and this may lead in turn to unwanted foam formation during film coating by machine. Reducing the amount of emulsifiers and protective colloids is not readily possible, since in that case the polymer dispersions are usually not sufficiently stable, being unstable to shearing, for example, and may undergo coagulation, particularly in the course of their industrial production on the metric ton scale.

WO 2011/154920 describes a two-stage preparation of aqueous polymer dispersions for the purpose of producing composite films. In that case the polymer prepared in the first stage acts as a protective colloid during the polymerization of the second stage. In view of the presence of protective colloid, machine application to films may be accompanied by unwanted foam formation and/or by undesirable stabilization of foam.

Aqueous acrylate copolymer dispersions are described in WO 00/50480, for use as laminating adhesives. Relatively large quantities of emulsifier are used, and there is no neutralization during the polymerization.

GB 2070037 describes pressure-sensitive adhesive dispersions where the polymerization initially takes place with little or no emulsifier and then considerable amounts of emulsifier are added, and where the neutralizing agent is already present at the start of the polymerization. Uses as laminating adhesives for producing composite films are not described.

The object was to provide aqueous polymer dispersions which are suitable as adhesives, especially for producing composite films, where the polymer dispersions on machine application to polymer films exhibit extremely little foaming or none and at the same time, in spite of only a very low content, or none, of emulsifiers and/or protective colloids, are extremely stable, more particularly stable to shear, do not suffer coagulation, and have good adhesive bonding values, in terms for example of peel strength and thermal stability.

It has been found that the object can be achieved by the polymer dispersion elucidated in more detail below and by the method for producing it. A subject of the invention is an aqueous polymer dispersion comprising polymer particles dispersed in water and

having an average particle diameter of greater than 200 nm, preferably greater than 250 nm, and a monomodal particle size distribution, and

having a uniform glass transition temperature,

prepared by radical emulsion polymerization of a single monomer mixture (i.e., by one-stage preparation) comprising ethylenically unsaturated, radically polymerizable monomers, using a polymer seed,

less than 0.8 part by weight, preferably less than or equal to 0.5 part by weight, of emulsifier per 100 parts by weight of monomers,

without addition of protective colloids and without formation of protective colloids in situ, where the monomer mixture consists of

a) at least 60 wt %, based on the total amount of monomers, of at least one monomer selected from the group consisting of C1 to C20 alkyl acrylates, C1 to C20 alkyl methacrylates, vinyl esters of carboxylic acids containing up to 20 carbons, vinylaromatics having up to 20 carbons, vinyl halides, vinyl ethers of alcohols containing 1 to 10 carbons, aliphatic hydrocarbons having 2 to 8 carbons and one or two double bonds, and mixtures of these monomers,

b) at least 0.1 wt %, based on the total amount of monomers, of at least one monomer having at least one acid group;

c) optionally at least one further monomer, different from the monomers a) and b);

where the feed of the monomer mixture during the polymerization takes place with a first and with at least one second feed rate, the first feed rate being preferably slower than the second feed rate, and where the acid groups of the monomers b) are wholly or partly neutralized during the emulsion polymerization by feeding of a base, where the feed of the base begins during the emulsion polymerization after at least 5 wt %, preferably 10 to 70 wt %, of the total monomer mixture is present in the reaction vessel under polymerization conditions.

Another subject of the invention is a corresponding method for producing the aqueous polymer dispersions.

The principle of the method of the invention is based on the seed-controlled formation of uniform, large polymer particles in aqueous dispersion, with large-scale avoidance of formation of water-soluble oligomers and polymers.

Another subject of the invention is a two-component adhesive comprising a polymer dispersion of the invention in a first component, and at least one crosslinker reactive with the first component in a second component.

Another subject of the invention is the use of the aqueous polymer dispersion of the invention as an adhesive, more particularly as a laminating adhesive, for producing—for example—composite films.

Another subject of the invention is a composite film which comprises a first and at least one second film which are bonded to one another using an adhesive comprising an aqueous polymer dispersion of the invention or a two-component adhesive of the invention.

Another subject of the invention is a method for producing composite films, where an aqueous polymer dispersion of the invention is provided and at least two films are bonded to one another using the aqueous polymer dispersion.

The text below occasionally uses the designation “(meth)acryl . . . ” and similar designations as an abbreviating notation for “acryl . . . or methacryl . . . ”. In the designation Cx alkyl (meth)acrylate and analogous designations, x denotes the number of carbons (carbon atoms) in the alkyl group.

The glass transition temperature is determined by differential scanning calorimetry (ASTM D 3418-08, midpoint temperature). The glass transition temperature of the polymer in the polymer dispersion is the glass transition temperature obtained when evaluating the second heating curve (heating rate 20° C./min). The polymer particles have a uniform glass transition temperature. This means that in the measurement of the glass transition temperature only a single glass transition temperature is measured.

Particle diameters and particle size distribution are measured by photon correlation spectroscopy (ISO standard 13321:1996).

The polymer dispersions produced in accordance with the invention are obtainable by radical emulsion polymerization of ethylenically unsaturated compounds (monomers). This polymerization takes place without emulsifier or with little emulsifier in the sense that less than 0.8, preferably less than or equal to 0.5, part by weight of emulsifier is added per 100 parts by weight of monomers in order to stabilize the polymer dispersion of the invention. Emulsifiers are nonpolymeric, amphiphilic, surface-active substances that are added to the polymerization mixture before or after the polymerization. Small amounts of emulsifiers, originating for example from the use of emulsifier-stabilized polymer seed are not detrimental in this context. Preference is given to the use in total of less than 0.3 part by weight or less than 0.2 part by weight of emulsifier, as for example of 0.05 to 0.8 part by weight, or of 0.05 to 0.5 part by weight, or of 0.05 to 0.3 part by weight, based on 100 parts by weight of monomers, or no emulsifier.

The polymerization takes place without addition of protective colloids and without formation of protective colloids in situ. Protective colloids are polymeric compounds which on solvation bind large quantities of water and are capable of stabilizing dispersions of water-insoluble polymers. In contrast to emulsifiers, they generally do not lower the interfacial tension between polymer particles and water. The number-average molecular weight of protective colloids is situated, for example, at above 1000 g/mol.

Monomers a)

The monomer mixture consists of at least 60 wt %, preferably at least 80 wt %, as for example from 80 to 99.9 wt %, more preferably at least 90 wt %, based on the total amount of monomers, of at least one monomer a) selected from the group consisting of C1 to C2 alkyl acrylates, C1 to C20 alkyl methacrylates, vinyl esters of carboxylic acids containing up to 20 carbons, vinylaromatics having up to 20 carbons, vinyl halides, vinyl ethers of alcohols containing 1 to 10 carbons, aliphatic hydrocarbons having 2 to 8 carbons and one or two double bonds, and mixtures of these monomers.

Suitable monomers a) are, for example, (meth)acrylic acid alkyl esters with a C₁-C₁₀ alkyl radical, such as methyl methacrylate, methyl acrylate, n-butyl acrylate, ethyl acrylate and 2-ethylhexyl acrylate, and also behenyl (meth)acrylate, isobutyl acrylate, tert-butyl (meth)acrylate, and cyclohexyl (meth)acrylate. In particular, mixtures of the alkyl (meth)acrylates are also suitable. Vinyl esters of carboxylic acids having 1 to 20 carbons are, for example, vinyl laurate, vinyl stearate, vinyl propionate, Versatic acid vinyl esters, and vinyl acetate. Useful vinylaromatic compounds include vinyltoluene, alpha- and para-methylstyrene, alpha-butylstyrene, 4-n-butylstyrene, 4-n-decylstyrene and, preferably, styrene. The vinyl halides are ethylenically unsaturated compounds substituted by chlorine, fluorine or bromine, preferably vinyl chloride and vinylidene chloride. Examples of vinyl ethers which may be mentioned are vinyl methyl ether or vinyl isobutyl ether. Preference is given to vinyl ethers of alcohols comprising 1 to 4 carbons. Hydrocarbons having 4 to 8 carbons and two olefinic double bonds include butadiene, isoprene and chloroprene. Preferred as monomers a) are the C₁ to C₁₀ alkyl acrylates and methacrylates, more particularly C₁ to C₈ alkyl acrylates and methacrylates, and also styrene, and mixtures thereof. Especially preferred are methyl acrylate, methyl methacrylate, ethyl acrylate, n-butyl acrylate, n-butyl methacrylate, n-hexyl acrylate, octyl acrylate and 2-ethylhexyl acrylate, 2-propylheptyl acrylate, styrene, and also mixtures of these monomers.

Monomers b)

The monomer mixture consists to an extent of at least 0.1 wt %, more particularly from 0.1 to 5 wt % or from 0.5 to 3 wt %, based on the total amount of monomers, of at least one ethylenically unsaturated monomer having at least one acid group (acid monomer). The acid monomers b) comprise monomers which contain at least one acid group, and also their anhydrides and salts thereof. The monomers b) include alpha,beta-monoethylenically unsaturated monocarboxylic and dicarboxylic acids, monoesters of alpha,beta-monoethylenically unsaturated dicarboxylic acids, the anhydrides of the aforesaid alpha,beta-monoethylenically unsaturated carboxylic acids, and also ethylenically unsaturated sulfonic acids, phosphonic acids or dihydrogenphosphates and their water-soluble salts, as for example their alkali metal salts. Examples thereof are acrylic acid, methacrylic acid, itaconic acid, maleic acid, fumaric acid, crotonic acid, vinylacetic acid, and vinyllactic acid. Examples of suitable ethylenically unsaturated sulfonic acids include vinylsulfonic acid, styrenesulfonic acid, acrylamidomethylpropanesulfonic acid, sulfopropyl acrylate and sulfopropyl methacrylate. Preferred monomers b) are alpha,beta-monoethylenically unsaturated C3-C8 carboxylic acids and C4-C8 dicarboxylic acids, e.g., itaconic acid, crotonic acid, vinylacetic acid, acrylamidoglycolic acid, acrylic acid and methacrylic acid, and also their anhydrides. Particularly preferred monomers b) are itaconic acid, acrylic acid and methacrylic acid.

The acid groups of the monomer b) are as yet not neutralized at the start of the polymerization. They are not neutralized, wholly or partially, until during the emulsion polymerization, by feeding of a base, where the feed of the base begins during the emulsion polymerization (i.e., after the start of the polymerization reaction) after at least 5 wt %, preferably 10 to 70 wt %, of the overall monomer mixture is present in the reaction vessel under polymerization conditions. Suitable bases are, for example, aqueous sodium hydroxide, aqueous potassium hydroxide, ammonia, or organic amines, preferably tertiary amines, more particularly trialkylamines having preferably 1 to 4 carbons in the alkyl group such as triethylamine for example.

Monomers c)

The monomer mixture may optionally comprise at least one further monomer c), which is different from the monomers a) and b). The monomers c) may be used, for example, from 0 to 10 wt % or from 0 to 5 wt %, more particularly from 0.1 to 10 wt % or from 0.1 to 5 wt % or from 0.2 to 3 wt %, based on the total amount of monomers.

Monomers c) are, for example, neutral and/or nonionic monomers with increased solubility in water, examples being the amides or the N-alkylolamides of the aforesaid carboxylic acids, as for example acrylamide, methacrylamide, N-methylolacrylamide and N-methylolmethacrylamide, or phenyloxyethyl glycol mono(meth)acrylate.

Further monomers c) are also, for example, monomers containing hydroxyl groups, more particularly the hydroxyalkyl esters of the aforesaid alpha,beta-monoethylenically unsaturated carboxylic acids, preferably C₁-C₁₀ hydroxyalkyl (meth)acrylates such as, for example, hydroxyethyl acrylate, hydroxyethyl methacrylate, hydroxypropyl acrylate or hydroxypropyl methacrylate, and also 4-hydroxybutyl acrylate.

Further monomers c) are also, for example, monomers containing amino groups, more particularly the aminoalkyl esters of the aforesaid alpha,beta-monoethylenically unsaturated carboxylic acids, preferably C₁-C₁₀ aminoalkyl(meth)acrylates such as, for example, 2-aminoethyl-(meth)acrylate or tert-butylaminoethyl methacrylate.

Additionally contemplated as monomers c) are the nitriles of alpha,beta -monoethylenically unsaturated C3-C8 carboxylic acids, such as acrylonitrile or methacrylonitrile for example.

Other suitable monomers c) are bifunctional monomers which as well as an ethylenically unsaturated double bond have at least one glycidyl group, oxazoline group, ureido group, ureidoanalogous group or carbonyl group. Examples of glycidyl group monomers are ethylenically unsaturated glycidyl ethers and glycidyl esters, e.g., vinyl, allyl and methallyl glycidyl ethers, and glycidyl (meth)acrylate.

Examples of carbonyl group monomers are the diacetonylamides of the abovementioned ethylenically unsaturated carboxylic acids, e.g., diacetone(meth)acrylamide, and the esters of acetylacetic acid with the abovementioned hydroxyalkyl esters of ethylenically unsaturated carboxylic acids, e.g., acetylacetoxyethyl (meth)acrylate.

Examples of oxazoline group monomers c) are those of the formula:

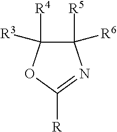

where the radicals have the following definitions:

R is a C₂₋₂₀ alkenyl radical comprising at least one ethylenically unsaturated group;

R³, R⁴, R⁵ and R⁶ are each selected independently of one another from H, halogen and C₁₋₂₀ alkyl,

C₂₋₂₀ alkenyl, C₆₋₂₀ aryl, C₇₋₃₂ arylalkyl, C₁₋₂₀ hydroxyalkyl, C₁₋₂₀ aminoalkyl and C₁₋₂₀ haloalkyl, preferably selected from H, halogen and C₁₋₂₀ alkyl.

With more particular preference the oxazoline monomers comprise at least one monomer selected from the group consisting 2-vinyl-2-oxazoline, 2-vinyl-4-methyl-2-oxazoline, 2-vinyl-5-methyl-2-oxazoline, 2-vinyl-4-ethyl-2-oxazoline, 2-vinyl-4,4-dimethyl-2-oxazoline, 2-vinyl-5,5-dimethyl-2-oxazoline, 2-vinyl-4,4,5,5-teramethyl-2-oxazoline, 2-osopropenyl-2-oxazoline, 2-isopropenyl-4-methyl-2-oxazoline, 2-isopropenyl-5-methyl-2-oxazoline, 2-isopropenyl-4-ethyl-2-oxazoline, 2-isopropenyl-5-ethyl-2-oxazoline, 2-isopropenyl-4,4-dimethyl-2-oxazoline, 2- isopropenyl-5,5-dimethyl-2-oxazoline and 2-isopropenyl-4,4,5,5-tetramethyl-2-oxazoline. Particularly preferred is the use of 2-vinyl-2-oxazoline and/or 2-isopropenyl-2-oxazoline; especially preferred is 2-isopropenyl-2-oxazoline (iPOx).

Examples of ureido group or ureido-analogous group monomers c) are, for example, those of the formula

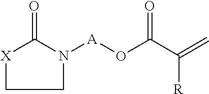

where X is CH₂, O, NH or NR¹ and R¹ is a C1 to C4 alkyl group, R is hydrogen or methyl, and A is a divalent linking group, preferably a C1 to C10 alkyl group or a C2 to C4 alkyl group. Particularly preferred are ureidoalkyl (meth)acrylates having 1 to 10 carbons, preferably 2 to 4 carbons, in the alkyl group, more particularly ureidoethyl methacrylate (UMA).

Further examples of monomers c) are crosslinking monomers which have more than one radically polymerizable group, more particularly two or more (meth)acrylate groups, such as butanediol di(meth)acrylate or allyl methacrylate, for example.

Preferred monomers c) are those which allow postcrosslinking of the polymer, with polyfunctional amines, hydrazides, isocyanates or alcohols, for example. Crosslinking is also possible through metal-salt crosslinking of the carboxyl groups, using polyvalent metal cations, e.g., Zn or Al.

Suitable crosslinking may be accomplished, for example, by the polymer containing keto groups or aldehyde groups (preferably 0.0001 to 1 mol, or 0.0002 to 0.10 mol, or 0.0006 to 0.03 mol) and the polymer dispersion additionally containing a compound having at least two functional groups, more particularly 2 to 5 functional groups, which enter into a crosslinking reaction with the keto or aldehyde groups. The keto or aldehyde groups may be bonded to the polymer through copolymerization of suitable monomers c). Suitable monomers c) are, for example, acrolein, methacrolein, vinyl alkyl ketones having 1 to 20, preferably 1 to 10, carbons in the alkyl radical, formylstyrene, (meth)acrylic acid alkyl esters having one or two keto or aldehyde groups, or one aldehyde groups and one keto group, in the alkyl radical, the alkyl radical preferably comprising a total of 3 to 10 carbons, e.g. (meth)acryloyloxyalkylpropanals. Also suitable, furthermore, are N-oxoalkyl(meth)acrylamides. Particularly preferred are acetoacetyl(meth)acrylate, acetoacetoxyethyl(meth)acrylate and especially diacetoneacrylamide. Examples of compounds which are able to enter into a crosslinking reaction with the keto or aldehyde groups are compounds having hydrazide, hydroxylamine, oxime ether or amino groups. Suitable compounds having hydrazide groups are, for example, polycarboxylic hydrazides having a molar weight of up to 500 g/mol. Preferred hydrazide compounds are dicarboxylic dihydrazides having preferably 2 to 10 carbons. Examples include oxalic dihydrazide, malonic dihydrazide, succinic dihydrazide, glutaric dihydrazide, adipic dihydrazide, sebacic dihydrazide, maleic dihydrazide, fumaric dihydrazide, itaconic dihydrazide and/or isophthalic dihydrazide. Particularly preferred are adipic dihydrazide, sebacic dihydrazide and isophthalic dihydrazide. Examples of suitable compounds having amino groups are ethylenediamine, propylenediamine, tetramethylenediamine, pentamethylenediamine, hexamethylenediamine, diethylenetriamine, triethylenetetramine, polyethyleneimines, partly hydrolyzed polyvinylformamides, ethylene oxide and propylene oxide adducts such as the “Jeffamines”, cyclohexanediamine and xylylenediamine. The compound having the functional groups may be added to any point in time to the composition, or to the dispersion of the polymer. In the aqueous dispersion there is as yet no crosslinking with the keto or aldehyde groups. Crosslinking occurs on the coated substrate only in the course of drying. The amount of the compound having the functional groups is preferably made such that the molar ratio of the functional groups to the keto and/or aldehyde groups of the polymer is 1:10 to 10:1, especially 1:5 to 5:1, particularly preferably 1:2 to 2:1 and most preferably 1:1.3 to 1.3:1. Especially preferred are equimolar amounts of the functional groups and of the keto and/or aldehyde groups.

The monomers of the polymerization are preferably selected such that the calculated glass transition temperature is in the range from −40° C. to +15° C., more particularly from −35° C. to +10° C. The actual measured glass transition temperature of the polymer in the polymer dispersion of the invention is also preferably in the range from −40° C. to +15° C., more particularly from −35° C. to +10° C.

By purposive variation of monomer type and quantity, those skilled in the art are able according to the invention to prepare aqueous polymeric compositions whose polymers have a glass transition temperature in the desired range. Orientation is possible by means of the Fox equation. According to Fox (T. G. Fox, Bull. Am. Phys. Soc. 1956 [Ser. II] 1, page 123, and according to Ullmann's Encyclopädie der technischen Chemie, Vol. 19, page 18, 4th edition, Verlag Chemie, Weinheim, 1980), the glass transition temperature of copolymers is given to a good approximation by:

1/T_{g}=x¹/T_{g}¹+x²/T_{g}²+. . . . xⁿ/T_{g}ⁿ,

where x¹, x², . . . . xⁿ are the mass fractions of the monomers 1, 2, . . . . n and T_{g}¹, T_{g}², . . . . T_{g}ⁿ are the glass transition temperatures in degrees kelvin of the polymers synthesized from only one of the monomers 1, 2, . . . . n at a time. The T_{g} values for the homopolymers of the majority of monomers are known and are listed for example in Ullmann's Ecyclopedia of Industrial Chemistry, Vol. A21, 5th edition, page 169, VCH Weinheim, 1992; further sources for glass transition temperatures of homopolymers are, for example, J. Brandrup, E. H. Immergut, Polymer Handbook, 1^{st} Ed., J. Wiley, N.Y. 1966, 2^{nd} Ed. J. Wiley, N.Y. 1975, and 3^{rd} Ed. J. Wiley, N.Y. 1989.

In one embodiment of the invention the polymerization takes place with use of at least one chain transfer agent. By this means it is possible to reduce the molar mass of the emulsion polymer through a chain termination reaction. The chain transfer agents are bonded to the polymer in this procedure, generally to the chain end. The amount of the chain transfer agents is especially 0.05 to 4 parts by weight, more preferably 0.05 to 0.8 part by weight, and very preferably 0.1 to 0.6 part by weight, per 100 parts by weight of the monomers to be polymerized. Suitable chain transfer agents are, for example, compounds having a thiol group such as tert-butyl mercaptan, thioglycolic acid ethylhexyl ester, mercaptoethanol, mercaptopropyltrimethoxysilane or tert-dodecyl mercaptan. The chain transfer agents are preferably compounds of low molecular mass, having a molar weight of less than 2000, more particularly less than 1000 g/mol. Preferred are 2-ethylhexyl thioglycolate (EHTG), isooctyl 3-mercaptopropionate (IOMPA) and tertdodecyl mercaptan (tDMK).

The polymerization takes place with seed control, i.e., in the presence of polymer seed (seed latex). Seed latex is an aqueous dispersion of finely divided polymer particles having an average particle diameter of preferably 20 to 40 nm. Seed latex is used in an amount of preferably 0.01 to 0.5 part by weight, more preferably of 0.03 to 0.3 part by weight, or of 0.03 to less than or equal to 0.1 part by weight, per 100 parts by weight of monomers. Suitability is possessed for example by a latex based on polystyrene or based on polymethyl methacrylate. A preferred seed latex is polystyrene seed.

The polymer dispersion of the invention is prepared by emulsion polymerization. Emulsion polymerization comprises polymerizing ethylenically unsaturated compounds (monomers) in water using typically ionic and/or nonionic emulsifiers and/or protective colloids or stabilizers as surface-active compounds to stabilize the monomer droplets and the polymer particles subsequently formed from the monomers. In accordance with the invention, however, the polymerization takes place with little emulsifier and without addition or formation of protective colloids. The resulting polymer dispersion is stabilized by the specific regime. This regime is based on a slow initial monomer feed in the presence of a very small amount of polymer seed (seed control), followed by the neutralization of the acid monomers in the course of the polymerization.

Acid groups in the polymer are neutralized by the feeding of a neutralizing agent during the polymerization, with the acid groups being neutralized wholly or partly by the feeding of a base, the feed of the base beginning during the emulsion polymerization after at least 5 wt %, preferably 10-70 wt %, of the total monomer mixture is present in the reaction vessel under polymerization conditions. The neutralizing agent may be added, for example, in a separate feed parallel to the feeding of the monomer mixture. After feeding of all of the monomers, the polymerization vessel preferably comprises the amount of neutralizing agent required for neutralizing at least 10% and preferably from 10% to 100% or from 25% to 90% acid equivalents.

The monomer mixture is added after the start of the polymerization reaction, by feeding of the monomer mixture at a first and at at least one second feed rate, it being possible for the first feed rate to be slower than the second feed rate. The first feed rate preferably is slower than the second feed rate. For example, the (average) feed rate is increased by a factor of 2 to 10 after 3 to 30 wt %, preferably 5 to 20 wt %, of the total monomer mixture has been added. The feed rate in this case may be increased in one or more stages or continuously.

The emulsion polymerization may be initiated using water-soluble initiators. Examples of water-soluble initiators are ammonium salts and alkali metal salts of peroxodisulfuric acid, e.g., sodium peroxodisulfate, hydrogen peroxide, or organic peroxide, e.g. tert-butyl hydroperoxide. Also suitable as initiator are reduction-oxidation (redox) initiator systems. Redox initiator systems consist of at least one generally inorganic reducing agent and an inorganic or organic oxidizing agent. The oxidant component is, for example, the emulsion polymerization initiators already mentioned hereinabove. The reductant components are, for example, alkali metal salts of sulfurous acid, for example sodium sulfite, sodium hydrogensulfite, alkali metal salts of disulfurous acid such as sodium disulfite, bisulfite addition compounds of aliphatic aldehydes and ketones, such as acetone bisulfite or reducing agents such as hydroxymethanesulfinic acid and the salts thereof, or ascorbic acid. The redox initiator systems may be employed with co-use of soluble metal compounds whose metallic component may appear in a plurality of oxidation states. Typical redox initiator systems are, for example, ascorbic acid/iron(II) sulfate/sodium peroxydisulfate, tert-butyl hydroperoxide/sodium disulfite, tert-butyl hydroperoxide/sodium hydroxymethanesulfinate. The individual components, for example the reductant component, may also be mixtures, for example a mixture of the sodium salt of hydroxymethanesulfinic acid and sodium disulfite.

The initiators cited are generally employed in the form of aqueous solutions, the lower concentration limit being determined by the amount of water acceptable in the dispersion and the upper limit being determined by the solubility in water of the particular compound. The concentration of the initiators is generally from 0.1 to 30 wt %, preferably from 0.5 to 20 wt % and more preferably from 1.0 to 10 wt % based on the monomers to be polymerized. It is also possible to use two or more different initiators in the emulsion polymerization.

The emulsion polymerization takes place in general at 30 to 130° C., preferably at 50 to 90° C. The polymerization medium may consist either solely of water or of mixtures of water and liquids miscible therein such as methanol. Preference is given to using solely water. In the polymerization, a polymer seed is introduced initially for more effective establishment of the particle size.

The manner in which the initiator is added to the polymerization vessel over the course of the free-radical aqueous emulsion polymerization is known to those of ordinary skill in the art. It may be either initially charged to the polymerization vessel in its entirety or employed continuously or in a staged manner at the rate of its consumption over the course of the free-radical aqueous emulsion polymerization. This specifically depends on the chemical nature of the initiator system and on the polymerization temperature. Preference is given to initially charging a portion and supplying the remainder to the polymerization zone at the rate of its consumption. In order to remove the residual monomers, it is common after the end of the emulsion polymerization proper, i.e., after a monomer conversion of at least 95%, to add initiator as well. In the feed process, the individual components may be added to the reactor from above, from the side or from below through the reactor floor.

The emulsion polymerization generally affords aqueous dispersions of the polymer having solids contents of from 15 to 75 wt %, preferably from 40 to 60 wt % and more preferably not less than 50 wt %.

The polymer thus prepared is used preferably in the form of its aqueous dispersion. The size distribution of the dispersion particles is monomodal. The average particle diameter of the polymer particles dispersed in the aqueous dispersion is greater than 200 nm, preferably greater than 250 nm, e.g., from 200 nm to 400 nm or from 250 nm to 350 nm. Average particle diameters x_{PCS} and particle size distribution are measured by photon correlation spectroscopy (ISO standard 13321:1996). The size distribution of the dispersion particles is monomodal when measurement of the particle size distribution contains only one single maximum.

The pH of the polymer dispersion is preferably adjusted to a pH greater than 5, more particularly to a pH of between 5.5 and 8.

The polymer dispersions of the invention can be used in aqueous adhesive preparations, for the production, for example, of laminates, i.e., in aqueous laminating adhesive preparations for the bonding of substrates of large surface area, more particularly for the production of composite films.

The present invention hence also provides a method for producing composite films that uses an aqueous adhesive preparation comprising at least one polymer dispersion of the invention or a two-component adhesive of the invention. In this method, the aqueous polymer dispersions may be used as they are or after formulation with customary auxiliaries. Examples of customary auxiliaries are crosslinkers, wetting agents, thickeners, light stabilizers, biocides, defoamers, and so on. The adhesive preparations of the invention do not necessarily require the addition of defoamers, since their particular advantage is that they are particularly low-foaming on application to substrates.

In the method for producing composite films, at least two films are bonded to one another using the aqueous polymer dispersion. In this method, the polymer dispersion of the invention, or a preparation formulated accordingly, is applied to the large-surface-area substrates to be bonded, preferably with a layer thickness of 0.1 to 20 g/m², more preferably 1 to 7 g/m², by means, for example, of knife coating, spreading, etc. Customary coating techniques may be employed, examples being roller coating, reverse roller coating, gravure roller coating, reverse gravure roller coating, brush coating, rod coating, spray coating, airbrush coating, meniscus coating, curtain coating or dip coating. After a short time for the water of the dispersion to evaporate (preferably after 1 to 60 seconds), the coated substrate may then be laminated with a second substrate, the temperature being able for example to be 20 to 200° C., preferably 20 to 100° C., and the pressure being able, for example, to be 100 to 3000 kN/m², preferably 300 to 2000 kN/m².

The polymer dispersion of the invention may be employed as a one-component composition, i.e. without additional crosslinking agents, more particularly without isocyanate crosslinkers. However, the polymer dispersion of the invention may also be used as a two-component adhesive, in which case a crosslinking component is added, such as a water-emulsifiable isocyanate for example. At least one of the films may be metallized or printed on the side coated with the adhesive. Examples of suitable substrates include polymer films, more particularly films of polyethylene (PE), oriented polypropylene (OPP), unoriented polypropylene (CPP), polyamide (PA), polyethylene terephthalate (PET), polyacetate, cellophane, polymer films coated (vapor coated) with metal, e.g., aluminum (metallized films for short), or metal foils, composed of aluminum, for example. The stated foils and films may be bonded to one another or to a film or foil of another type—for example polymer films to metal foils, different polymer films with one another, etc. The stated foils and films may also, for example, have been printed with printing inks.

One embodiment of the invention is a composite film produced using one of the aqueous polymer dispersions of the invention described above, the material of a first film being selected from OPP, CPP, PE, PET and PA, and the material of a second film or foil being selected from OPP, CPP, PE, PET, PA and metal foil. In one embodiment of the invention, the first film or foil and/or the second film or foil is printed or metallized on the respective size to be coated with the polymer dispersion of the invention. The thickness of the substrate films may amount for example to from 5 to 100 μm, preferably from 5 to 40 μm.

Surface treatment of the foil or film substrates ahead of coating with a polymer dispersion of the invention is not absolutely necessary. However, better results can be obtained if the surfaces of the film or foil substrates are modified prior to coating. In this case it is possible to employ customary surface treatments, such as corona treatment in order to boost the adhesion. The corona treatment or other surface treatments are carried out to the extent required for sufficient wettability with the coating composition. Customarily, corona treatment of approximately 10 watts per square meter per minute is sufficient for this purpose. Alternatively or additionally it is also possible, optionally, to use primers or tie coats between foil or film substrate and adhesive coating. Furthermore, other, additional functional layers may be present on the composite films, examples being barrier layers, print layers, color layers or varnish layers, or protective layers. These functional layers may be located externally, i.e., on the side of the foil or film substrate facing away from the adhesive-coated side, or internally, between foil or film substrate and adhesive layer.

Particular advantages of the production method of the invention and of the products of the invention are the following in particular:
good peel strengths in composite film lamination, both immediately after laminating (immediate strength) and at elevated temperatures (thermal stability)
good shear stability of the polymer dispersion despite extremely low stabilizer content (emulsifiers, protective colloids)
improved foaming behavior relative to conventional laminating adhesives on application to substrates.

### EXAMPLES

### ABBREVIATIONS

tBHP tert-butyl hydroperoxide
IS itaconic acid
AA acrylic acid
MAA methacrylic acid
EHA 2-ethylhexyl acrylate
S styrene
EA ethyl acrylate
MA methyl acrylate
MMA methyl methacrylate
nBA n-butyl acrylate
HPA hydroxypropyl acrylate
DAAM diacetoneacrylamide
iPOx 2-isopropenyl-2-oxazoline
Basonat® Basonat® HW 100, water-dispersible polyisocyanate based on isocyanuratized hexamethylene diisocyanate
Basonat® LR 9056 water-dispersible polyisocyanate based on isocyanuratized hexamethylene diisocyanate
Dowfax® 2A1 alkyldiphenyl oxide disulfonate, emulsifier
Disponil® LDBS 20 emulsifier
SC solids content
LT light transmissibility; parameter for determining differences in particle size. In this case the polymer dispersion is diluted to a solids content of 0.01% and the light transmissibility is measured in comparison to pure water.
Tg (calc.) glass transition temperature as calculated by the Fox equation from the glass transition temperature of the homopolymers of the monomers present in the copolymer and their weight fraction:

1/Tg=xA/TgA+xB/TgB+xC/TgC+. . .
Tg: calculated glass transition temperature of the copolymer
TgA: glass transition temperature of the homopolymer of monomer A
TgB, TgC: Tg correspondingly for monomers B, C, etc.
xA: mass of monomer A/total mass of copolymer,
xB, xC correspondingly for monomers B, C etc.
Tg from DSC: glass transition temperature as measured by DSC
PS from HDC: average particle diameter as measured by photon correlation spectroscopy (ISO 13321:1996)

Example Dispersion 1a

A mixture of 136.38 g of water and 1.82 g of a 33% fine polystyrene seed (in water) is heated to 85° C. and stirred for 5 minutes. Then 8.57 g of 7% strength sodium peroxodisulfate solution are added and stirring is carried out again for 5 minutes. Next is the metered addition of 91.15 g of the monomer mixture over 1 hour, after which 820.4 g of the monomer mixture are metered in over 2 hours. Taking place in parallel with this is the metered addition of 34.29 g of sodium peroxodisulfate (7% strength solution in water) over 3 hours. As soon as the 2nd part of the monomers is metered in, the metered addition of 19.15 g of 3.1% strength ammonia solution takes place in parallel with this over 2 hours.

Monomer Feed 1a:

228.84 g water

3 g Disponil® LDBS 20 (20% in water)

85.71 g 7% itaconic acid solution

6 g methacrylic acid

90 g methyl acrylate

498 g n-butyl acrylate

This is followed by metered addition of 49.25 g of 3.1% strength ammonia solution over 30 minutes. After that, 58.22 g of 1.85% strength acetone bisulfite solution and 61.98 g of tert-butyl hydroperoxide solution (0.195%) are metered in over 2 hours.

In examples 1 b-d, the polymerization procedure is retained while the monomer composition is varied. In the case of example 1d, additionally, at the end, 32.48 g of 4.62% strength adipic di-hydrazide solution are added.

Monomer Feed 1 b:

228.84 g water

3 g Disponil® LDBS 20 (20% in water)

85.71 g 7% itaconic acid solution

72 g styrene

57 g methyl acrylate

465 g n-butyl acrylate

Monomer Feed 1 c:

310 g water

3 g Disponil® LDBS 20 (20% in water)

12 g acrylic acid

120 g styrene

468 g n-butyl acrylate

Monomer Feed 1 d:

399.12 g water

3 g Disponil® LDBS 20 (20% in water)

85.71 g 7% itaconic acid solution

6 g methacrylic acid

90 g methyl acrylate

495 g n-butyl acrylate

3 g diacetoneacrylamide

Example Dispersion 1e:

A mixture of 180 g of water and 1.82 g of a 33% fine polystyrene seed (in water) is heated to 85° C. and stirred for 5 minutes. Then 8.57 g of 7% strength sodium peroxodisulfate solution are added and stirring is carried out again for 5 minutes. Next is the metered addition of 608.9 g of the monomer mixture over 2 hours, after which 310.43 g of the monomer mixture are metered in over 1 hour. Taking place in parallel with this is the metered addition of 34.29 g of sodium peroxodisulfate (7% strength solution in water) over 3 hours 15 minutes. As soon as the 2nd part of the monomers is metered in, the metered addition of 68.4 g of 3.07% strength ammonia solution takes place in parallel with this over 15 minutes.

Monomer Feed 1 e:

236.58 g water

3 g Disponil® LDBS 20 (20% in water)

85.71 g 7% itaconic acid solution

12 g methacrylic acid

12 g styrene

53.4 g methyl acrylate

510.6 g n-butyl acrylate

6 g 2-isopropenyl-2-oxazoline

Subsequently 49.25 g of 3.07% strength ammonia solution are metered in over 30 minutes. Thereafter 59.67 g of 2.11% strength acetone bisulfite solution with 2.41 g of Lumiten® I-SC and 21 g of tert-butyl hydroperoxide solution (10%) are metered in over 2 hours.

### COMPARATIVE EXAMPLES

In examples 2a and 2b below, metering takes place in two stages and both the monomer composition and the procedure are varied by comparison with examples la-le. Furthermore, in examples 2a and 2b, little or no emulsifier is used. The protocols are based on dispersion in accordance with W02011/154920.

Example Dispersion 2a (Comparative)

A mixture of 136.38 g of water and 5.45 g of a 33% fine polystyrene seed (in water) is heated to 80° C. and stirred for 5 minutes. Then 42.86 g of 7% strength sodium peroxodisulfate solution are added and stirring is carried out again for 5 minutes. This is followed by the metered addition of 20 g of the monomer mixture 2a1 over 10 minutes and subsequently 265.27 g of the monomer mixture 2a1 over 50 minutes. The temperature here is raised to 85° C. This is followed by the metered addition of 40 g of the monomer mixture 2a2 over 10 minutes and subsequently 581.45 g of the monomer mixture 2a2, and also 54 g of 5.55% strength ammonia solution and 8.57 g of sodium peroxodisulfate (7% strength solution in water) over 2 hours 50 minutes.

Monomer Feed 2a1:

49.98 g water

1.07 g Texapon® NSO (28% in water)

85.71 g 7% itaconic acid solution

12 g styrene

43.5 g methyl acrylate

93 g n-butyl acrylate

Monomer Feed 2a2:

171.66 g water

4.29 g Texapon® NSO (28% in water)

60 g styrene

13.5 g methyl acrylate

372 g n-butyl acrylate

Taking place subsequently is the metered addition of 17.14 g of sodium peroxodisulfate (7% solution in water) over 15 minutes. Thereafter 58.22 g of 1.85% strength acetone bisulfite solution and 61.98 g of tert-butyl hydroperoxide solution (1.94%) are metered in over 1 hour.

Example Dispersion 2b (Comparative):

A mixture of 462 g of water and 5.45 g of a 33% fine polystyrene seed (in water) is heated to 80° C. and stirred for 5 minutes. Then 42.86 g of 7% strength sodium peroxodisulfate solution are added and stirring is carried out again for 5 minutes. This is followed by the metered addition of 20 g of the monomer mixture 2b1 over 10 minutes and subsequently 109.48 g of the monomer mixture 2b1 over 30 minutes. Taking place after that are the metered addition of 40 g of the monomer mixture 2b2 over 15 minutes and subsequently 441.26 g of the monomer mixture 2b2 over 2 hours 45 minutes. The temperature here is increased to 95° C. over 3 hours. 30 minutes after the start of the metering of monomer mixture 2b2, 94.74 g of 2.22% strength ammonia solution are metered in. This is followed by the metered addition of 70.11 g of 2.57% strength sodium peroxodisulfate solution over 25 minutes. The temperature here is cooled to 85° C.

Monomer Feed 2b 1:

7.38 g water

2.1 g 2-ethylhexyl thioglycolate

15 g methacrylic acid

105 g ethyl acrylate

Monomer feed 2b 2:

1.26 g water

72 g styrene

360 g ethyl acrylate

48 g n-butyl acrylate

In comparative examples 3a, 3b and 3c below, there is variation in the monomer composition and in the metering of the monomers. The sodium peroxodisulfate solution is metered in parallel to the monomer feed. Examples 3a, 3b and 3c are modeled on examples in accordance with DE 19908183.

Example Dispersion 3a (Comparative):

A mixture of 136.38 g of water and 0.91 g of a 33% fine polystyrene seed (in water) is heated to 85° C. and stirred for 5 minutes. Then 4.29 g of 7% strength sodium peroxodisulfate solution are added and stirring is carried out again for 5 minutes. This is followed by the metered addition of 20 g of the monomer mixture over 10 minutes and subsequently 963.27 g of the monomer mixture over 2 hours 50 minutes. Taking place in parallel is the metered addition of 38.57 g of sodium peroxodisulfate (7% strength solution in water) over 3 hours.

Monomer Feed 3a:

274.98 g water

8 g Dowfax® 2A1

20.57 g Lumiten® I-SC

85.71 g 7% itaconic acid solution

6 g methacrylic acid

90 g methyl acrylate

498 g n-butyl acrylate

Subsequently a metered addition takes place of 58.22 g of 1.85% strength acetone bisulfite solution and 61.98 g of tert-butyl hydroperoxide solution (0.19%) over 2 hours.

Example Dispersions 3b and 3c (Comparative):

In comparative examples 3 b-c, the polymerization process is retained while the monomer composition is varied.

Monomer Feed 3b:

274.98 g water

8 g Dowfax® 2A1

20.57 g Lumiten® I-SC

85.71 g 7% itaconic acid solution

72 g styrene

57 g methyl acrylate

465 g n-butyl acrylate

Monomer Feed 3c:

355.86 g water

8 g Dowfax® 2A1

20.57 g Lumiten® I-SC

0.6 g tert-dodecyl mercaptan

6 g acrylic acid

90 g methyl methacrylate

504 g n-butyl acrylate

TABLE 1
Wet specimen values of the adhesive dispersions.

| | | | | | | Tg | PS |
|---|---|---|---|---|---|---|---|
| | | | Tg | | | from | from |
| | Monomer composition | Amount of | (calc.) | SC | LT | DSC | HDC |
| No. | [%] | emulsifier | [° C.] | [%] | [%] | [° C.] | [nm] |
| 1a. | 1 IA, 1 MAA, 15 MA, 83 | 0.1% Disponil ® | −33 | 47.6 | 53 | −33.6 | 280.6 |
| | nBA | LDBS 20 | | | | | |
| 1b. | 1 IA, 9.5 MA, 12 S, 77.5 | 0.1% Disponil ® | −25.1 | 47 | 52 | −24.5 | 258.7 |
| | nBA | LDBS 20 | | | | | |
| 1c. | 2 AA, 20 S, 78 nBA | 0.1% Disponil ® | −21.1 | 47 | 42 | −20.2 | 282.8 |
| | | LDBS 20 | | | | | |
| 1d. | 0.5 DAAM, 1 IA, 1 MAA, 15 | 0.1% Disponil ® | −32.5 | 46.8 | 55 | −33.8 | 280.4 |
| | MA, 82.5 nBA | LDBS 20 | | | | | |
| 1e. | 1 iPOx, 1 IA, 2 S, 2 MAA, | 0.11% Disponil ® | −33.2 | 45.1 | 56 | −33.9 | 274.1 |
| | 8.9 MA, 85.1 nBA | LDBS | | | | | |
| | | 20 | | | | | |
| 2a. | 1 MAA, 1 IA, 15 MA, 83 | 0.25% Texapon ® | −33 | 47.7 | 68 | −10.7 | 220.3 |
| | nBA | NSO | | | | −37.8 | |
| 2b. | 2.5 MAA, 8 nBA, 12 S, 77.5 | — | −2.9 | 46.9 | 78 | −1.3 | 55.9 |
| | EA | | | | | | 154.9 |
| 3a. | 1 MAA, 1 IS, 15 MA, 83 | 0.6% Dowfax ® | −33 | 46.9 | 47 | −35.1 | 378.5 |
| | nBA | 2A1, 0.24% | | | | | |
| | | Lumiten ® I-SC | | | | | |
| 3b. | 1 IA, 9.5 MA, 12 S, 77.5 | 0.6% Dowfax ® | −25.1 | 46.7 | 43 | −27 | 312.1 |
| | nBA | 2A1, 0.24% | | | | | |
| | | Lumiten ® I-SC | | | | | |
| 3c. | 1 AA, 15 MMA, 84 nBA | 0.6% Dowfax ® | −27.6 | 47.4 | 45 | −30.1 | 341 |
| | | 2A1, 0.24% | | | | | |
| | | Lumiten ® I-SC | | | | | |

Applications-Related Tests

Substrates, laminating films:

Polyethylene film, 50 μm thick, corona pretreated, surface tension >38 mN/m;

metallized cPP film 25 μm thick;

cPP film 25 μm thick, corona pretreated, surface tension >38 mN/m

Adhesive Application:

Directly to the corona pretreated side of the base film, with an application weight of 1.8-2.2 g/m² or 2.5-3.0 g/m² dry.

Dynamic Peel Resistance:

The base film is fixed on the laboratory coating unit with the pretreated side upward and the adhesive under test is knife-coated directly onto the film. The adhesive is dried for 2 minutes with a hot air blower and then the laminating film is placed on with a manual roller and pressed in the roller laminating station at 70° C. with a roll speed of 5 m/minute and a laminating pressure of 6.5 bar. After that, using a cutting stencil, the laminate is cut into strips 15 millimeters wide and subjected to various storage cycles. Following storage, the laminate strip is pulled apart on a tensile testing machine, and the force required to achieve this is recorded. The test takes place on a tensile testing machine at an angle of 90 degrees and a removal speed of 300 mm/min. The test strip is opened up on one side, with one of the resultant ends being clamped into the upper jaw and the other into the lower jaw of the tensile testing machine, and the test is commenced. The result reported is the average of the force from three individual measurements, in N/15 mm.

The specimens can be tested after different storage conditions:
1. immediately after laminating (<3 min)
2. after 24 h (at 23° C./50% rel. humidity)
3. after 7 d (at 23° C./50% rel. humidity)
4. after 24 h (at 23° C./50% rel. humidity) +7 d at 40° C./95% rel. humidity
5. after 24 h (at 23° C./50% rel. humidity) +7 d at 50° C. in Ketchup

Dynamic Peel Resistance at 90° C.:

The base film is fixed on the laboratory coating unit with the pretreated side upward and the adhesive under test is knife-coated directly onto the film. The adhesive is dried for 2 minutes with a hot air blower and then the laminating film is placed on with a manual roller and pressed in the roller laminating station at 70° C. with a roll speed of 5 m/minute and a laminating pressure of 6.5 bar. The laminate is then cut into strips 15 millimeters wide using the cutting stencil, and stored for a minimum of 24 hours at 23° C./50% relative humidity. Following storage, the laminate strip is pulled apart on a tensile testing machine with climate chamber at a temperature of 90° C., and the force required to achieve this is recorded. The test takes place on a tensile testing machine with climate chamber, at a removal speed of 300 mm/min. The test strip is opened up on one side, with one of the resultant ends being clamped into the upper jaw and the other into the lower jaw of the tensile testing machine, and the test is commenced. The measurement starts after a waiting time of 1 minute, for conditioning of the test strip. Evaluation: The result reported is the average of the force from three individual measurements, in N/15 millimeters.

Assessment of the Fracture Mode:
DT=printing ink transfer
MT=metal transfer
F=tack-free film on the substrate
A100=adhesive layer remains completely on the base film (adhesive fracture)
A0=adhesive layer detaches from the base film and passes to the laminating film (transfer)
A0/R=adhesive layer passes to the laminating film, but local residues are on the base film.
K=separation in the adhesive layer without detachment from a material (cohesive fracture)
K*=separation in the adhesive layer without detachment from a material (cohesive fracture); the adhesive has no residual tack
MB=partial or complete fracture of a film
Z=zippy, adhesive layer flakes away (clattering noise)

A100/R=adhesive layer remains fully on the base film, but local residues on the laminating film In-between stages are indicated by reporting the percentage adhesive remaining on the laminating film. Example: A30=30% of the adhesive has remained on the base film, 70% has passed to the laminating film.

TABLE 2
Adhesive values of selected adhesive dispersions,
without crosslinking, for various substrate surfaces

| | Peel resistance | Peel resistance | Peel resistance | |
|---|---|---|---|---|
| | after <3 min | after <24 h | at 90° C. | |
| | [N/15 mm]/ | [N/15 mm]/ | [N/15 mm]/ | |
| | fracture | fracture | fracture | |
| Ex. | mode | mode | mode | Films |
| 1a | 1.1/A80 | 0.9/A0 | 0.3/F | oPP |
| 1b | 0.8/A100 | 0.9/A0 | 0.4/K | (unprinted)/ |
| 1c | 0.7/A100 | 1.1/A100 | 0.2/K | metallized oPP |
| 2a | 0.7/A100 | 0.9/R | 0.3/K | |
| 3a | 0.7/A95 | 1.2/A50 | 0.4/K | |
| 3b | 0.6/A100 | 1.3/A100/K | 0.5/K | |
| 3c | 0.7/A100 | 1.3 K/A0 | 0.1/K | |
| 1a | 0.9/R | 1.3/K | 0.2/A10 | oPP (printed)/ |
| 1b | 0.7/A100 | 0.8/A100 | 0.5/K | metalized oPP |
| 1c. | 0.6/A100 | 0.8/R | 0.2/K | |
| 2a | 0.6/A100 | 0.9/R | 0.1/A0 | |
| 1a | 1.3/R | 1.8/F/R | 0.6/K | PET (printed)/ |
| 1b | 1.3/A100 | 1.6/F/R | 0.5/K | metallized oPP |
| 1c | 1.2/A100 | 1.8/F/R | 0.4/K | |
| 2a | 0.9/A100 | 1.3/A100 | 0.4/F/R | |

This table shows that both the inventive examples and the comparative examples lend themselves well to use as adhesives in composite film lamination.

TABLE 3
Adhesive values of selected adhesive dispersions,
with and without crosslinking, for various substrate surfaces.

| | Peel resistance | Peel resistance | Peel resistance | |
|---|---|---|---|---|
| | after <3 min | after <24 h | at 90° C. | |
| | [N/15 mm]/ | [N/15 mm]/ | [N/15 mm]/ | |
| | fracture | fracture | fracture | |
| Ex. | mode | mode | mode | Films |
| 1a | 1.6/A 100 | 1.6/A 100 | 0.4/A 50 | PET (printed)/ |
| 1a¹⁾ | 3.0/K | 3.2/A0 | 0.7/A 50 | PE (printed) |
| 1d | 2.6/A100 | 3.2/K | 0.7/A K | |
| 1e | 2.1/A100 | 3.0/MB | 0.4/F | |

¹⁾+ 3% Basonat ® LR 9056

Frit Foam Test:

The dispersion under test is filled up to the mark (corresponding to 50 ml of dispersion at about 6.5 cm) in a glass tube whose lower end has a glass frit located in it. This tube is located on a glass flask with air admission. The air is passed by means of a flowmeter (1 bar, 1 I/h) over the glass flask and through the glass frit, from below, into the dispersion contained in the glass tube. Measurement was made of the time taken to reach a foam height of 40 cm.

TABLE 4
Foam behavior of the adhesive dispersions

| | Foam height 40 cm reached |
|---|---|
| Dispersion | [min] |
| 1a | >60¹⁾ |
| 1b | >60¹⁾ |
| 1c | >60¹⁾ |
| 1e | >60¹⁾ |
| 2a | 37 |
| 2b | 13 |
| 3a | 14 |
| 3b | 13 |
| 3c | 16 |

¹⁾The test was discontinued after 60 minutes, the dispersions having shown no significant buildup of foam.

1. An aqueous polymer dispersion comprising polymer particles dispersed in water,
having an average particle diameter of greater than 200 nm,
a monomodal particle size distribution, and
a uniform glass transition temperature,
prepared by radical emulsion polymerization of a single monomer mixture comprising ethylenically unsaturated, radically polymerizable monomers, using a polymer seed, less than 0.8 part by weight of emulsifier per 100 parts by weight of monomers, without addition of protective colloids and without formation of protective colloids in situ,
where the monomer mixture consists of
a) at least 60 wt %, based on the total amount of monomers, of at least one monomer selected from the group consisting of C1 to C20 alkyl acrylates, C1 to C20 alkyl methacrylates, vinyl esters of carboxylic acids containing up to 20 carbons, vinylaromatics having up to 20 carbons, vinyl halides, vinyl ethers of alcohols containing 1 to 10 carbons, aliphatic hydrocarbons having 2 to 8 carbons and one or two double bonds, and mixtures of these monomers,
b) at least 0.1 wt %, based on the total amount of monomers, of at least one monomer having at least one acid group;
c) optionally at least one further monomer, different from the monomers a) and b);
where a feed of the monomer mixture during the polymerization takes place with a first and with at least one second feed rate, the first feed rate being slower than the second feed rate, and where the acid groups of the monomers b) are wholly or partly neutralized during the emulsion polymerization by feeding of a base, where the feed of the base begins during the emulsion polymerization after at least 5 wt % of the total monomer mixture is present in the reaction vessel under polymerization conditions.

2. The polymer dispersion according to claim 1, wherein the monomers b) having at least one acid group are selected from the group consisting of acrylic acid, methacrylic acid, itaconic acid, maleic acid, fumaric acid, crotonic acid, vinylacetic acid, vinyllactic acid, vinylsulfonic acid, styrenesulfonic acid, acrylamidomethylpropanesulfonic acid, sulfopropyl acrylate, sulfopropyl methacrylate, and mixtures of these monomers.

3. The polymer dispersion according to claim 1, wherein the monomers a) are selected from the group consisting of C1 to C10 alkyl acrylates, C1 to C10 alkyl methacrylates, styrene, and mixtures of these monomers.

4. The polymer dispersion according to claim 1, wherein the monomers a) are used in an amount of at least 80 wt %, based on the total amount of the monomers, and are selected from the group consisting of C1 to C10 alkyl acrylates, C1 to C10 alkyl methacrylates, styrene, and a mixture thereof and the monomers b) are used in an amount of 0.5 to 5 wt %, based on the total amount of the monomers, and are selected from the group consisting of acrylic acid, methacrylic acid, itaconic acid, and a mixture thereof.

5. The polymer dispersion according to claim 1, wherein the glass transition temperature is in range from −40° C. to +15° C.

6. The polymer dispersion according to claim 1, wherein at least one chain transfer agent is used in the polymerization.

7. The polymer dispersion according to claim 1, wherein the polymer seed is used in an amount of 0.01 to 0.5 part by weight per 100 parts by weight of monomers and/or the polymer seed has an average particle diameter of 20 to 40 nm.

8. The polymer dispersion according to claim 1, wherein the monomers c) are used in an amount of 0.1 to 10 wt %, based on the total amount of the monomers, and are selected from the group consisting of amides of ethylenically unsaturated carboxylic acids, N-alkylolamides of ethylenically unsaturated carboxylic acids, phenyloxyethyl glycol mono(meth)acrylate, hydroxyalkyl esters of ethylenically unsaturated carboxylic acids, monomers containing amino groups, nitriles of unsaturated C3 to C8 carboxylic acids, bifunctional monomers which as well as an ethylenically unsaturated double bond have at least one glycidyl group, oxazoline group, ureido group, ureido-analogous group or carbonyl group, and crosslinking monomers which have more than one radically polymerizable group.

9. A two-component adhesive comprising the polymer dispersion according to claim 1 in a first component, and at least one crosslinker reactive with the first component in a second component.

10. A method for producing an aqueous polymer dispersion comprising polymer particles dispersed in water and
having an average particle diameter of greater than 200 nm,
a monomodal particle size distribution, and
a uniform glass transition temperature,
prepared by radical emulsion polymerization of a single monomer mixture comprising ethylenically unsaturated, radically polymerizable monomers, using a polymer seed, less than 0.8 part by weight of emulsifier per 100 parts by weight of monomers, without addition of protective colloids and without formation of protective colloids in situ,
where the monomer mixture consists of
a) at least 60 wt %, based on the total amount of monomers, of at least one monomer selected from the group consisting of C1 to C20 alkyl acrylates, C1 to C20 alkyl methacrylates, vinyl esters of carboxylic acids containing up to 20 carbons, vinylaromatics having up to 20 carbons, vinyl halides, vinyl ethers of alcohols containing 1 to 10 carbons, aliphatic hydrocarbons having 2 to 8 carbons and one or two double bonds, and mixtures of these monomers,
b) at least 0.1 wt %, based on the total amount of monomers, of at least one monomer having at least one acid group;
c) optionally at least one further monomer, different from the monomers a) and b);
where the feed of the monomer mixture during the polymerization takes place with a first and with at least one second feed rate, the first feed rate being slower than the second feed rate; and
where the acid groups of the monomers b) are wholly or partly neutralized during the emulsion polymerization by feeding of a base, where the feed of the base begins during the emulsion polymerization after at least 5 wt % of the total monomer mixture is present in the reaction vessel under polymerization conditions.

11. An adhesive comprising the aqueous polymer dispersion according to claim 1.

12. A composite film comprising a first and at least one second film which are bonded to one another using an adhesive comprising the aqueous polymer dispersion according to claim 1.

13. A method for producing a composite film, which comprises providing the aqueous polymer dispersion according to claim 1 and bonding at least two films to one another using the aqueous polymer dispersion.
